(19) United States
(12) Patent Application Publication
(10) Pub. No.: US 2024/0251129 A1
(43) Pub. Date: Jul. 25, 2024

(54) SUGGESTING MEDIA CONTENT TO ACCOMPANY A JOURNEY

(71) Applicant: GOOGLE LLC, Mountain View, CA (US)

(72) Inventor: Matthew Sharifi, Mountain View, CA (US)

(21) Appl. No.: 18/016,211

(22) PCT Filed: Aug. 24, 2022
(86) PCT No.: PCT/US22/41349

§ 371 Date: Jan. 13, 2023

(51) Int. Cl. H04N 21/45; G01C 21/36; H04N 21/414; H04N 21/482

(52) U.S. Cl. CPC H04N 21/4524; G01C 21/3697; H04N 21/41407; H04N 21/4826

(57) ABSTRACT

To provide media content tailored to a user's route, a computing device receives a request for navigation directions to a destination location, and obtains a set of navigation directions for traveling on a route to the destination location. The computing device also obtains candidate media content items to play during the route, and selects one or more of the candidate media content items to play during the route based on characteristics of the candidate media content items and characteristics of the route. Then the computing device provides the set of navigation directions and an indication of the selected one or more media content items to a user for presentation during the route. The selected one or more media content items are automatically presented upon receiving a selection by the user to initiate a navigation session for traveling along the route in accordance with the set of navigation directions.

### FIELD OF THE DISCLOSURE

The present disclosure relates to providing tailored content recommendations and, more particularly, to identifying media content items to present to a user during the user's route.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many users request map and navigation data for various geographic locations. Software applications executing in computers, smartphones, embedded devices, etc., generate step-by-step navigation directions in response to receiving input from a user, specifying the starting point and the destination. The navigation directions are typically generated for a route which guides the user to the destination in the shortest amount of time.

Additionally, many users listen to media content while traveling on their routes, such as podcasts, music, audio books, etc. However, in some scenarios the duration of the media content may not match the duration of the route, and the user may have to select additional media content or may have to stop listening to or watching the media content in the middle as the user reaches their destination.

### SUMMARY

To recommend media content that will keep the user entertained for the duration of the trip without the user arriving at their destination before the media content finishes playing, a content tailoring system receives a request for navigation directions to a destination location and obtains a set of navigation directions to the destination location along a route. The content tailoring system then identifies one or more media content items to recommend playing during the route.

For example, the content tailoring system may retrieve a large set of candidate media content items. The user may generate a list of candidate media content items, and/or the content tailoring system may obtain the set of candidate media content items by accessing content from various applications on the user's client device, for example via application programming interfaces (APIs). In yet other implementations, the content tailoring system may crawl applications on the user's client device or the Internet for candidate media content items.

In any event, the content tailoring system then analyzes characteristics of each candidate media content item and compares them to characteristics of the route to select a subset of the candidate media content items to recommend playing during the route. For example, the content tailoring system may compare the durations of each of the candidate media content items to the duration of the route to identify a candidate media content item or a few candidate media content items having a total duration that matches the duration of the route, or is within a threshold time interval of the duration of the route (e.g., ±5 minutes). The content tailoring system may also select the media content item(s) to play based on the type of content media content item(s) being suitable for the mode of transportation. For example, if the mode of transportation is driving or biking, the content tailoring system may filter out videos from the set of candidate media content items.

In other implementations, the content tailoring system may rank the candidate media content items based on relevance to the user's preferences and/or interests, recency, etc. Then the content tailoring system may boost candidate media content items in the rankings based on a comparison of the characteristics of the candidate media content items to the characteristics of the route (e.g., the durations, the type of content and mode of transportation for the route, etc.). Then the content tailoring system may select candidate media content items ranked above a threshold ranking, such as the highest ranking candidate media content item. In other implementations, the content tailoring system may first select the highest ranking candidate media content item and then continue selecting the next highest ranking candidate media content item until the total duration of the selected media content items matches the duration of the route.

In any event, the content tailoring system may provide the set of navigation directions to the user along with an indication of the selected media content item(s). When the user initiates a navigation session to travel to the destination location using the set of navigation directions, the content tailoring system may automatically play the selected media content item(s). The content tailoring system may also modify the playback rate of the selected media content item(s) so that the duration of playback matches the duration of the trip.

In this manner, the content tailoring system provides content that will play for the entire journey without the user having to select additional content during the trip. This improves the user experience and reduces driver distraction by preventing a driver from potentially having to select additional content items in the middle of the trip, thereby improving driver safety. Additionally, the content tailoring system controls operation of the client device by adjusting the playback rate of the content to match the duration of the trip. Furthermore, the content tailoring system can anticipate segments on the route where the client device is likely to have poor network connectivity and can pre-fetch content likely to be played during those segments. It may be that the content tailoring system only pre-fetches the content likely to be played during those segments likely to have poor network connectivity, and not content for segments of the route in which network connectivity is likely to be acceptable. This further improves the user experience by preventing delays in audio or video playback and reduces potential network downtime without having to pre-fetch an entire media content item which is memory intensive, time consuming, and requires a significant amount of bandwidth. By only pre-fetching the media content likely to be played during poor network connectivity segments, more efficient use of bandwidth and memory is achieved.

One example embodiment of the techniques of this disclosure is a method for providing media content tailored to a user's route. The method includes receiving a request for navigation directions to a destination location, and obtaining a set of navigation directions for traveling on a route to the destination location. Additionally, the method includes obtaining a plurality of candidate media content items to play during the route, selecting one or more of the plurality of candidate media content items to play during the route based on one or more characteristics of the plurality of candidate media content items and one or more characteristics of the route, and providing the set of navigation directions and an indication of the selected one or more media content items to a user for presentation during the route. The selected one or more media content items are automatically presented upon receiving a selection by the user to initiate a navigation session for traveling along the route in accordance with the set of navigation directions.

Another example embodiment of the techniques of this disclosure is a computing device for providing media content tailored to a user's route. The computing device includes one or more processors, and a computer-readable memory, which is optionally non-transitory, coupled to the one or more processors and storing instructions thereon. The instructions, when executed by the one or more processors, cause the computing device to receive a request for navigation directions to a destination location, and obtain a set of navigation directions for traveling on a route to the destination location. The instructions also cause the computing device to obtain a plurality of candidate media content items to play during the route, select one or more of the plurality of candidate media content items to play during the route based on one or more characteristics of the plurality of candidate media content items and one or more characteristics of the route, and provide the set of navigation directions and an indication of the selected one or more media content items to a user for presentation during the route. The selected one or more media content items are automatically presented upon receiving a selection by the user to initiate a navigation session for traveling along the route in accordance with the set of navigation directions.

Yet another example embodiment of the techniques of this disclosure is a computer-readable memory, which is optionally non-transitory, storing instructions thereon. The instructions, when executed by one or more processors, cause the one or more processors to receive a request for navigation directions to a destination location, and obtain a set of navigation directions for traveling on a route to the destination location. Additionally, the instructions cause the one or more processors to obtain a plurality of candidate media content items to play during the route, receive a selection of one or more of the plurality of candidate media content items to play during the route, and provide the set of navigation directions and an indication of the selected one or more media content items to a user for presentation during the route. The selected one or more media content items are automatically presented upon receiving a selection by the user to initiate a navigation session for traveling along the route in accordance with the set of navigation directions.

Another example embodiment of the techniques of this disclosure is a method for providing media content tailored to a user's route. The method includes receiving a request for navigation directions to a destination location, and obtaining a set of navigation directions for traveling on a route to the destination location. Additionally, the method includes obtaining a plurality of candidate media content items to play during the route, receiving a selection of one or more of the plurality of candidate media content items to play during the route, and providing the set of navigation directions and an indication of the selected one or more media content items to a user for presentation during the route. The selected one or more media content items are automatically presented upon receiving a selection by the user to initiate a navigation session for traveling along the route in accordance with the set of navigation directions.

### BRIEF DESCRIPTION OF THE DRAWINGS

FIG. 1 is a block diagram of an example system in which techniques for providing media content tailored to a user's route can be implemented;

FIG. 2 is an example navigation display for presenting a set of navigation directions for traveling to a destination location along a route and an indication of a recommended media content item to present during navigation.

FIG. 3 is another example navigation display including alternative routes to the destination location, and a recommended media content item to present during each alternative route.

FIG. 4 is a flow diagram of an example method for providing media content tailored to a user's route, which can be implemented in a server computing device.

### DETAILED DESCRIPTION

### Overview

Generally speaking, the techniques for providing tailored content recommendations can be implemented in one or several client devices, one or several network servers, one or several first or third-party content applications, or a system that includes a combination of these devices. However, for clarity, the examples below focus primarily on an embodiment in which a client device executing a mapping application obtains a request for navigation instructions for navigating a user from a starting location to a destination location along a route. For example, a user may request navigation directions from the user's current location to a destination location via the mapping application, and the client device may forward the request to a navigation server. The navigation server may then generate a set of navigation directions and transmit the set of navigation directions to the client device.

Additionally, the mapping application may communicate with other applications executing on the client device, such as first-party content applications or third-party content applications (e.g., via APIs or via server communications) to identify candidate media content items to recommend playing or to automatically select and play as the user navigates along the route. In some implementations, the mapping application may crawl the Internet to identify additional candidate media content items. The mapping application may then provide a set of identified candidate media content items to a server device to analyze characteristics of the candidate media content items in view of characteristics of the route to select media content item(s) to play during the route. Alternatively, the server device may identify the candidate media content items by invoking APIs of third-party content application providers, crawling the Internet, or retrieving first-party content application data at the server device, for example.

In some implementations, the server device may determine the duration of the route and filter out candidate media content items having durations that are more than a threshold amount longer (e.g., more than 10% longer) than the duration of the route. The server device may rank the candidate media content items based on relevance to the user's preferences and/or interests, recency, etc. Alternatively or additionally, the server device may rank the candidate media content items based on media content duration as compared to the duration of the route. Then, the server device may optionally boost candidate media content items in the rankings based on a comparison of the characteristics of the candidate media content items to the characteristics of the route (e.g., the durations, the type of content and mode of transportation for the route, previous media content items played during the same route, etc.). Whether boosted or not, the server device may select candidate media content items ranked above a threshold ranking, such as the highest ranking candidate media content item. In other implementations, the server device may first select the highest ranking candidate media content item and then continue selecting the next highest ranking candidate media content item until the total duration of the selected media content items matches the duration of the route.

In any event, the server device may then provide indication(s) of selected media content item(s) to the client device. The server device may also include indication(s) of playback rate(s) for each of the selected media content item(s).

Then the client device may provide the set of navigation directions to the user with a recommendation to play the selected media content item(s) during the route. In response to receiving a request from the user to initiate a navigation session using the set of navigation directions, the client device may automatically play the selected media content item(s) at the selected playback rate(s). Alternatively, the client device may automatically play the selected media content item(s) in response to receiving the indication(s) of the selected media content item(s) from the server device.

Media content, as used herein, may include radio shows, podcasts, audio books, music, advertisements, television programs, movies, videos, or any other types of media including an audio component.

### Example Hardware and Software Components

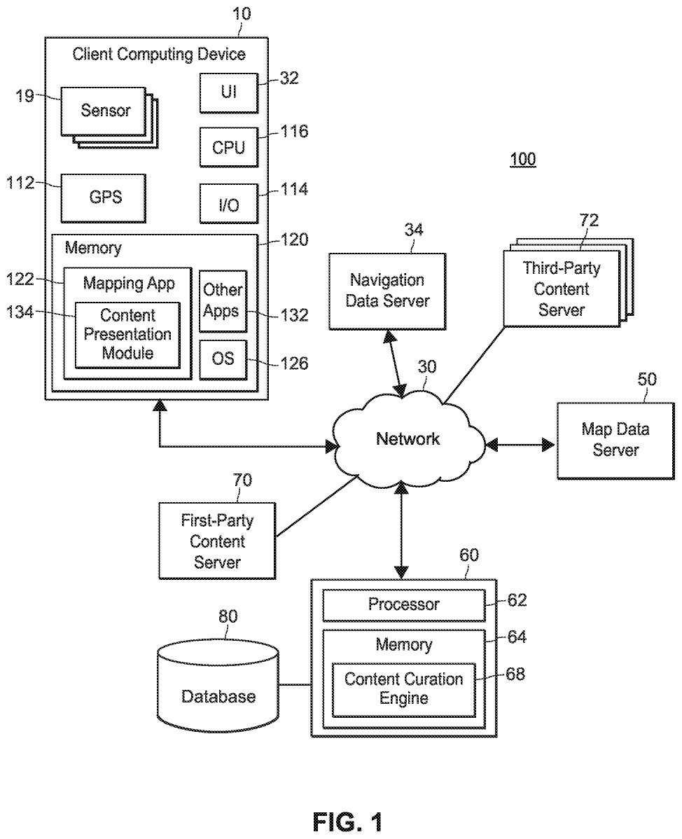

An example communication system 100 in which a content tailoring system can be implemented is illustrated in FIG. 1. The communication system 100 includes a client computing device 10 configured to execute a geographic application 122, which also can be referred to as “mapping application 122.” Depending on the implementation, the application 122 can display an interactive digital map, request and receive routing data to provide driving, walking, or other navigation directions including audio navigation directions, provide various geolocated content, etc. The client computing device 10 may be operated by a user displaying a digital map while navigating to various locations.

In addition to the client computing device 10, the communication system 100 includes a server device 60 configured to provide tailored content recommendations to the client device 10. The server device 60 can be communicatively coupled to a database 80 that stores, in an example implementation, user profile information such as content preferences (e.g., horror movies, documentaries, etc.), route-specific content preferences (e.g., talk radio on a morning route to work, music on an evening route home from work), media content items for a first-party content application, a subset of the first-party content application media content items in which the user indicated interest, etc.

More generally, the server device 60 can communicate with one or several databases that store any type of suitable geospatial information or information that can be linked to a geographic context and/or that store media content items. The communication system 100 also can include a navigation data server 34 that provides driving, walking, biking, or public transit directions, for example. Further, the communication system 100 can include a map data server 50 that provides map data to the server device 60 for generating a map display. Additionally, the communication system 100 can include third-party content server 72 that provide additional media content items to third-party content applications 72 on the client device 10. The third-party content applications 72 may include a large set of media content items and also may include a subset of the media content items in which the user has indicated interest in playing. In some implementations, the first and third-party content applications may stream the media content items on the client device 10. In other implementations, the client device 10 may download the media content items from the server device 60, a first-party content server 70, and/or third-party content servers 72. The devices operating in the communication system 100 can be interconnected via a communication network 30.

In various implementations, the client computing device 10 may be a smartphone or a tablet computer. The client computing device 10 may include a memory 120, one or more processors (CPUs) 116, a graphics processing unit (GPU) 112, an I/O module 114 including a microphone and speakers, a user interface (UI) 32, and one or several sensors 19 including a Global Positioning Service (GPS) module. The memory 120 can be a non-transitory memory and can include one or several suitable memory modules, such as random access memory (RAM), read-only memory (ROM), flash memory, other types of persistent memory, etc. The I/O module 114 may be a touch screen, for example. In various implementations, the client computing device 10 can include fewer components than illustrated in FIG. 1 or conversely, additional components. In other embodiments, the client computing device 10 may be any suitable portable or non-portable computing device. For example, the client computing device 10 may be a laptop computer, a desktop computer, a wearable device such as a smart watch or smart glasses, etc.

The memory 120 stores an operating system (OS) 126, which can be any type of suitable mobile or general-purpose operating system. The OS 126 can include application programming interface (API) functions that allow applications to retrieve sensor readings. For example, a software application configured to execute on the computing device 10 can include instructions that invoke an OS 126 API for retrieving a current location of the client computing device 10 at that instant. The API can also return a quantitative indication of how certain the API is of the estimate (e.g., as a percentage).

The memory 120 also stores a mapping application 122, which is configured to generate interactive digital maps and/or perform other geographic functions, as indicated above. The mapping application 122 can receive navigation instructions and present a set of navigation directions for traveling along a route to a destination location. The mapping application 122 also can display driving, walking, or transit directions, and in general provide functions related to geography, geolocation, navigation, etc.

The mapping application 122 may include a content presentation module 134 which may obtain candidate media content items from other client applications 132 on the client device 10, including first-party content applications and/or third-party content applications. The content presentation module 134 may also obtain candidate media content items by crawling the Internet for media content items. In other implementations, the server device 60 may obtain the candidate media content items. In any event, the content presentation module 134 may present a set of navigation directions for traveling on a route to a destination location along with an indication of selected media content item(s) to play during the route.

In some implementations, the content presentation module 134 may present alternative sets of navigation directions for traveling along alternative routes to the destination location, for example via different modes of transport. For each alternative route, the content presentation module 134 may present an indication of a different set of selected media content item(s) to play during the alternative route. For example, for a route that includes public transportation, the content presentation module 134 may recommend playing a particular television show. For a route that includes driving, the content presentation module 134 may recommend playing a particular sports podcast. In other words, for routes that do not require the user to control a vehicle, video or audio-only content may be suggested, however for routes that do require the user to control a vehicle, video content may not be suggested and audio-only content may be suggested. By basing content suggestions on the mode of transport, safety may be improved as the distraction to the user is minimized.

In response to receiving a selection of a user control to initiate a navigation session for traveling along the route in accordance with the set of navigation directions, the content presentation module 134 may automatically play the selected media content item(s), for example via the speakers 114 and/or UI 32 of the client device 10. In some implementations, the content presentation module 134 may also obtain a playback rate for playing each selected media content item, so that the duration of the selected media content item(s) matches the expected duration of the route.

Also in some implementations, the content presentation module 134 may adjust the playback rate for playing each selected media content item during the route. For example, if the expected duration of the route increases during the trip (e.g., due to traffic), the content presentation module 134 may decrease the playback rate for a selected media content item. On the other hand, if the expected duration of the route decreases during the trip, the content presentation module 134 may decrease the playback rate for a selected media content item. More generally, the content presentation module 134 may adjust the playback rate in accordance with a change in the expected duration of the route as the user travels to the destination location. In this manner, the content presentation module 134 may adjust the playback rate ‘on the fly’ to ensure that content is played during the entire trip and/or during substantial portions of the trip without arriving at the destination before the content finishes playing.

In some implementations, the content presentation module 134 may not adjust the playback rate by more than a threshold amount. For example, the content presentation module 134 may adjust the playback rate within an accepted tolerance range (e.g., by ±10%). If the playback rate needs to be adjusted by more than the acceptable tolerance range for the duration of the selected media content item(s) to match the updated duration of the route, the content presentation module 134 may select an additional media content item to play during the route when the updated duration of the route is longer than duration of the selected media content item(s). On the other hand, the content presentation module 134 may not play one of the selected media content item(s) when the updated duration of the route is shorter than duration of the selected media content item(s).

Furthermore, the content presentation module 134 may receive an indication from the server device 60 that there is likely to be poor network connectivity at a particular segment of the route (e.g., the segment includes a tunnel or subway). For example, during that particular segment it may be unlikely that the client device 10 will be able to connect to a network 30, the network connectivity may be likely to be limited, or the network connection may be likely to have poor quality. More specifically, the quality of service (QOS) of the network connection may be likely to be below a threshold QoS metric, the bandwidth of the network may be below a threshold bandwidth, or a latency metric for the network communications may exceed a threshold latency metric. Based on a determination of what portion of the media content will be playing during that particular segment of the route, the content presentation module 134 may then pre-fetch the expected portion of the media content item which will be played during the particular segment of the route.

For example, the server device 60 may identify the portion of the media content item and provide an indication of the portion to the content presentation module 134 (e.g., Bill's Baseball Podcast from 2 minutes to 3 minutes 45 seconds). The content presentation module 134 may then pre-fetch the identified portion of the media content item from the first or third-party content server 70, 72, for example via an API, or may cause a first or third-party content application 132 to pre-fetch the identified portion of the media content item from the first or third-party content server 70, 72. The content presentation module 134 may cache the pre-fetched portion of the media content item. In other implementations, the server device 60 may pre-fetch the identified portion of the media content item from the first or third-party content server 70, 72 and may provide the pre-fetched content to the content presentation module 134 to cache the pre-fetched portion of the media content item.

Still further, in response to receiving a selection of a user control to pause the navigation session, the content presentation module 134 may also pause the currently playing media content item. Then if the user resumes the navigation session to the same destination location, the content presentation module 134 may resume playing the selected media content item(s) at the point the media content item was paused.

It is noted that although FIG. 1 illustrates the mapping application 122 as a standalone application, the functionality of the mapping application 122 also can be provided in the form of an online service accessible via a web browser executing on the client computing device 10, as a plug-in or extension for another software application executing on the client computing device 10, etc. The mapping application 122 generally can be provided in different versions for different respective operating systems. For example, the maker of the client computing device 10 can provide a Software Development Kit (SDK) including the mapping application 122 for the Android™ platform, another SDK for the iOS™ platform, etc.

In addition to the mapping application 122, the memory 120 stores other client applications 132, such as first-party content application and third-party content applications, including music applications, video applications, streaming applications, radio applications, social media applications, etc. which play media/audio content. These applications 132 may expose APIs for communicating with the mapping application 122.

In some implementations, the server device 60 includes one or more processors 62 and a memory 64. The memory 64 may be tangible, non-transitory memory and may include any types of suitable memory modules, including random access memory (RAM), read-only memory (ROM), flash memory, other types of persistent memory, etc. The memory 64 stores instructions executable on the processors 62 that make up a content curation engine 68, which can obtain a set of candidate media content items and one or more sets of navigation directions for traveling to a destination location along one or more routes, and select media content item(s) to play during the route based on characteristics of the candidate media content items and characteristics of the route.

The content curation engine 68 may filter out candidate media content items having durations which are more than a threshold amount longer than the expected duration of the route. The content curation engine 68 may then rank the remaining candidate media content items based on characteristics of each candidate media content item and/or characteristics of the route. For example, the content curation engine 68 may assign scores to several characteristics and combine the scores in any suitable manner to generate an overall score for each candidate media content item. Then the content curation engine 68 may rank the candidate media content items in accordance with their assigned scores.

In some implementations, the expected duration may be a portion of the total duration of the route. For example, the expected duration may be the duration for the portion of the route which includes a low volume of navigation instructions and does not require the user to have to focus as heavily on navigating. More specifically, the expected duration may include the duration of the portion of the route that includes traveling on a highway and does not involve frequent turns. The expected duration may be for the portion of the route where navigation instructions are provided at less than a threshold frequency. Then the content presentation module 134 may play selected content item(s) during the portion of the route corresponding to the expected duration and may automatically pause the selected content item(s) during the other portions of the route.

More specifically, the content curation engine 68 may assign a duration score to each candidate media content item based on the difference between the duration of the candidate media content item and the expected duration of the route. The duration score may be inversely proportional to the difference between the duration of the candidate media content item and the expected duration of the route, such that candidate media content items having durations which match with or are very similar to the expected duration of the route are scored highest.

The content curation engine 68 may also assign a mode of transportation score to each candidate media content item based on the content type and the mode of transportation for the route. When the mode of transportation requires the user to focus on the road, such as driving, walking, or biking, content types which include video may be scored below content types which only include audio. On the other hand, when the mode of transportation does not require the user to focus as closely on the road, such as public transportation, taxi or ride sharing, content types which include video may be scored above content types which only include audio or both content types may be scored the same.

Furthermore, the content curation engine 68 may assign a relevance score to each candidate media content item based on the user's interests or previous content selections, which may be stored in a user profile at the server device 60. For example, the user's interests may include a preference for financial podcasts, for true crime audio books, for country music, etc. Additionally, in some scenarios, the user may flag certain candidate media content items on a watch list. For example, the user may flag the candidate media content items within the respective applications 132 in which they are provided. The content curation engine 68 may obtain the watch lists by invoking APIs of the respective applications 132, receiving the watch lists from the client device 10 which invokes the APIs of the respective applications 132, communicating with the first-party content server 70, etc. Then the content curation engine 68 may increase the relevance score of candidate media content items flagged by the user to watch or listen to.

In addition to the relevance score, the content curation engine 68 may assign a route habit score to each candidate media content item based on an amount in which the candidate media content item aligns with the user's route habits. The user's route habits may also be stored in a user profile at the server device 60 and may indicate for example, that the user prefers radio on their morning route to work during the week, rock music on their evening trip home from work during the week, true crime podcasts on weekend road trips, etc. The content curation engine 68 may compare each candidate media content item to the user's route habits, the starting location of the route, the destination of the route, the time of day of the route, the day of the week of the route, and/or other route attributes (e.g., freeway driving, city driving, scenic roads, etc.) to assign the route habit scores.

Still further, the content curation engine 68 may assign a recency score to each candidate media content item based on how recently the candidate media content item was released. Candidate media content items released more recently may be scored higher.

The content curation engine 68 may then combine the scores in any suitable manner to generate an overall score for each candidate media content item. In some implementations, the content curation engine 68 may assign weights to each score and combine the weighted scores to generate the overall score. For example, the content curation engine 68 may assign higher weights to scores related to the route (e.g., the duration score, the route habit score, and the mode of transportation score) than scores which are not related to the route (e.g., the relevance score and the recency score). Then the content curation engine 68 may rank the candidate media content items in accordance with their overall scores. In an embodiment, the content curation engine 68 may rank the candidate media content items based on the duration score and/or the mode of transportation score, and not on the relevance score, route habit score or the recency score.

Additionally, in some implementations, the content curation engine 68 may assign different overall scores to each candidate media content item for different segments of the route. For example, when the mode of transportation is multi-modal, the content curation engine 68 may assign a first overall score and rank the candidate media content items for a first segment of the route having a first mode of transportation (e.g., public transportation), and may assign a second overall score and rank the candidate media content items for a second segment of the route having a second mode of transportation (e.g., driving). Then the content curation engine 68 may select a first media content item for the first segment of the route and a second media content item for the second segment of the route.

In other implementations, rather than assigning scores to each candidate media content item, the content curation engine 68 may train a machine learning model for ranking candidate media content items based on characteristics of the candidate media content items, characteristics of the route, and the content item previously selected by a user. For example, at several instances in time, the training data may include a list of available candidate media content items and their characteristics, characteristics of the route, and an indication of the media content item(s) from the list that the user selected to play during the route. The content curation engine 68 may then apply characteristics of candidate media content items and characteristics of a route to the machine learning model for the machine learning model to select media content item(s) to recommend playing, or play automatically, during the route.

The content curation engine 68 and the content presentation module 134 can operate as components of a content tailoring system. Alternatively, the content tailoring system can include only server-side components and simply provide the content presentation module 134 with instructions to present the navigation instructions and selected media content item(s). In other words, content tailoring techniques in these embodiments can be implemented transparently to the content presentation module 134. As another alternative, the entire functionality of the content curation engine 68 can be implemented in the content presentation module 134.

For simplicity, FIG. 1 illustrates the server device 60 as only one instance of a server. However, the server device 60 according to some implementations includes a group of one or more server devices, each equipped with one or more processors and capable of operating independently of the other server devices. Server devices operating in such a group can process requests from the client computing device 10 individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices.

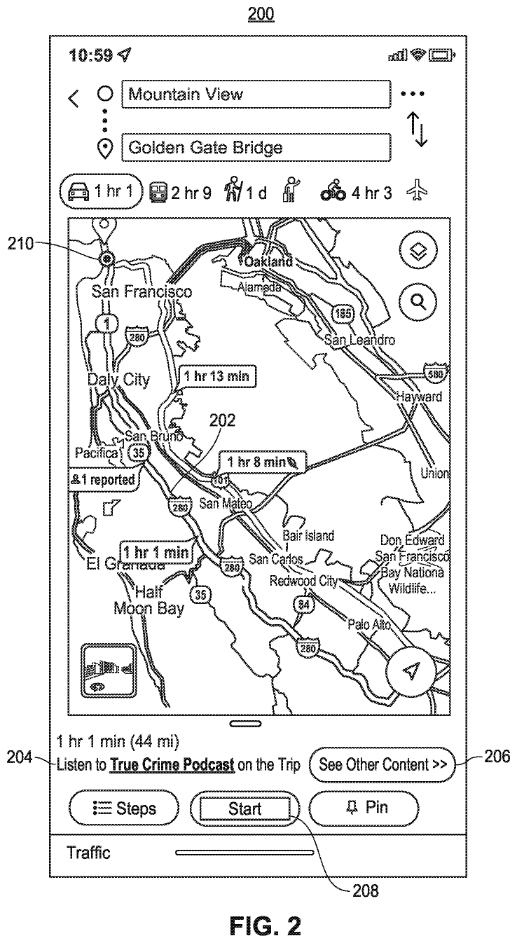

FIG. 2 illustrates an example navigation display 200 which may be presented on the client device 10 via the mapping application 122, and more specifically, the content presentation module 134. The navigation display 200 may include an indication of a route 202 for traveling to a destination location 210. The navigation display 200 may also include an indication of a recommended media content item 204 (e.g., “True Crime Podcast”) to present during navigation. The indication 204 may include a link for the user to view more information about the recommended media content item, such as a preview of the recommended media content item, a synopsis of the recommended media content item, a description of the actors in the recommended media content item, an indication of the content application presenting the recommended media content item, etc.

While the navigation display 200 includes a single recommended media content item 204, this is merely one example for case of illustration only. In other example scenarios, the navigation display 200 may include several recommended media content items to play consecutively during the trip if there is enough time. For example, as shown in the navigation display 200 the expected duration of the route is 1 hour 1 minute. The True Crime Podcast 204 may have a duration of 1 hour and the client device 10 and/or the server device 60 may adjust the playback rate of the True Crime Podcast 204 to increase the duration of the True Crime Podcast 204 to 1 hour 1 minute.

However, in other example scenarios, the content curation engine 68 may select a different media content item to recommend which has a duration of 30 minutes and second media content item which also has a duration of 30 minutes. Then the navigation display 200 may include both the first and second media content items as recommended media content items to present during navigation.

For example, the content curation engine 68 may rank candidate media content items and select the highest ranking candidate media content item or may select candidate media content items in order of ranking until the total duration of the candidate media content items is within a threshold time interval of the expected duration of the route. More specifically, the content curation engine 68 may select the highest ranking candidate media content item and compare the duration of the highest ranking candidate media content item to the expected duration of the route 202. If the expected duration of the route 202 is longer than the duration of the highest ranking candidate media content item by more than the threshold time interval, the content curation engine 68 may select the next highest ranking candidate media content item and compare the total duration of the two highest ranking candidate media content items to the expected duration of the route 202.

If the total duration of the two highest ranking candidate media content items is within the threshold time interval of the expected duration of the route 202, the content curation engine 68 may provide the two highest ranking candidate media content items to the client device 10 for display via the navigation display 200. On the other hand, if the total duration of the two highest ranking candidate media content items is longer than the expected duration of the route 202 by more than the threshold time interval, the content curation engine 68 may select the next highest ranking candidate media content item and compare the total duration of the first and third highest ranking candidate media content items to the expected duration of the route 202. The content curation engine 68 may continue to go down the rankings until the content curation engine 68 identifies a subset of the candidate media content items having a total duration which is within the threshold time interval of the expected duration of the route. By selecting a subset of the candidate media content items having a total duration which is within the threshold time interval of the expected duration of the route, media may be provided seamlessly to the user for the duration of the route without excessive distortion.

In other implementations, the content curation engine 68 may select a subset of the candidate media content items ranked above a threshold ranking, where the threshold ranking is selected such that a total duration of the selected subset of candidate media content items is within a threshold time interval of the expected duration of the route 202.

Additionally, the navigation display 200 may include a user control 206 to view additional media content items. As mentioned above, the single recommended media content item 204 may be the highest ranking media content item. In response to receiving a selection of the user control 206, the content presentation module 134 may present a complete set of candidate media content items in their ranked order. In other implementations, the content presentation module 134 may present a subset of candidate media content items ranked above a threshold ranking (e.g., the top candidate media content items). In this manner, if the user is not interested in viewing or listening to the recommended media content item 204, the user may select another media content item in the set of subset of candidate media content items.

In yet other implementations, the navigation display 200 may include the set of candidate media content items in their ranked order or the set of candidate media content items may not be ranked. For example, upon filtering out candidate media content items having durations which are more than a threshold amount longer than the expected duration of the route 202, the content curation engine 68 may provide the filtered candidate media content items to the content presentation module 134 for display to the user via the navigation display 200. The user may then select one or more of the filtered candidate media content items (e.g., via user controls) to play during the route 202.

Still further, the navigation display 200 may include a user control 208 to initiate a navigation session for traveling along the route 202. In response to receiving a selection of the user control 208, the content presentation module 134 may not only initiate the navigation session but may also automatically begin presenting the recommended media content item 204.

For example, when the recommended media content item 204 corresponds to a third-party content application 132, the content presentation module 134 may invoke an API of the third-party content application 132 to retrieve content data for the recommended content item 204 from the third-party content server 72 and stream the recommended media content item 204. When the recommended media content item 204 corresponds to a first-party content application 132, the content presentation module 134 may communicate directly with the first-party content server 70 to retrieve content data for the recommended content item 204 from the first-party content server 70. In other implementations, the content presentation module 134 may request the content data from server device 60 which may communicate with the first-party content server 70 to retrieve the content data and provide the content data to the content presentation module 134. In any event, the content presentation module 134 may automatically begin presenting the recommended media content item 204 via the UI 32 and/or the speakers 114.

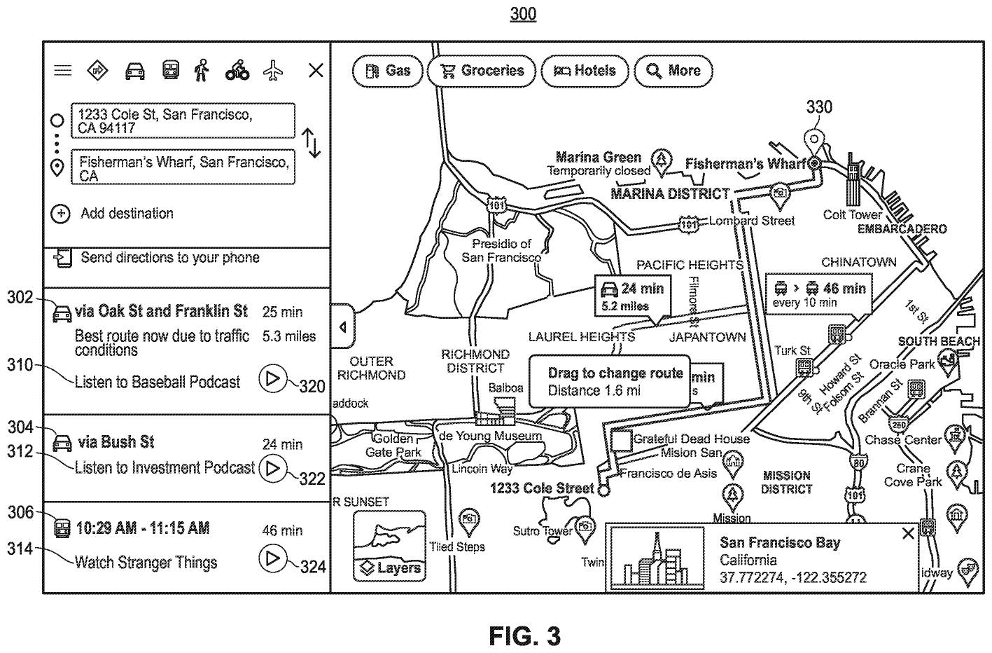

FIG. 3 illustrates another example navigation display 300 which may be presented on the client device 10 via the mapping application 122, and more specifically, the content presentation module 134. The navigation display 300 may include alternative sets of navigation directions for traveling along alternative routes 302-306 to the destination location 330. For example, the user may provide a request for navigation directions from their current location to the destination location 330 via the mapping application 122. The mapping application 122 may transmit the request to the server device 60 which may communicate with the navigation data server 34 to retrieve the alternative sets of navigation directions for traveling along alternative routes 302-306 to the destination location 330.

The navigation data server 34 may rank routes to the destination location 330 based on distance, duration, traffic conditions, etc., and may provide the alternative routes 302-306 to the destination location 330 which are ranked above a threshold ranking (e.g., the top three routes). In some implementations, the navigation data server 34 may identify alternative routes 302-306 which include different modes of transportation, such as an alternative route 302 for driving to the destination location 330, and an alternative route 306 for traveling to the destination location 330 via public transportation. The navigation data server 34 may also identify an alternative route which includes multiple modes of transportation, such as walking from the current location to a bus stop, taking the bus to another bus stop, and walking to the destination 330.

In any event, the server device 60 may then provide the retrieved alternative routes 302-306 to the client device 10 for display via the navigation display 300. For each alternative route 302-306, the content curation engine 68 may select recommended content item(s) 310-314 to play during navigation of the alternative route 302-306. The content curation engine 68 may then provide indications of each of alternative routes 302-306 with indications of the different sets of candidate media content item(s) 310-314 corresponding to each alternative route. For example, the first alternative route 302 is for driving to the destination location 330 via Oak and Franklin Street. For the first alternative route 302, the content curation engine 68 recommends listening to the “Baseball Podcast” 310 which is an audio podcast so the user is not distracted while driving. The second alternative route 304 is for driving to the destination location 330 via Bush Street. For the second alternative route 304, the content curation engine 68 recommends listening to the “Investments Podcast” 312 which is also an audio podcast so the user is not distracted while driving. The third alternative route 306 is for traveling to the destination location 330 via public transportation. For the third alternative route 306, the content curation engine 68 recommends watching “Stranger Things” 314 which is a television show. Since the user is not driving or operating a vehicle, the user can safely watch a video while traveling on the route.

For each of the recommended content items 310-314, the navigation display 300 includes a user control 320-324 to play the recommended content item 310-314. In response to receiving a selection of the user control 320-324, the content presentation module 134 may play the recommended content item 310-314 or a preview of the recommended content item 310-314. In other implementations, the content presentation module 134 may automatically play the recommended content item 310-314 in response to the user selecting the corresponding alternative route 302-306 to initiate a navigation session. For example, if the user selects the first alternative route 302, the content presentation module 134 may automatically play the “Baseball Podcast” 310.

### Example Method for Providing Tailored Content Recommendations

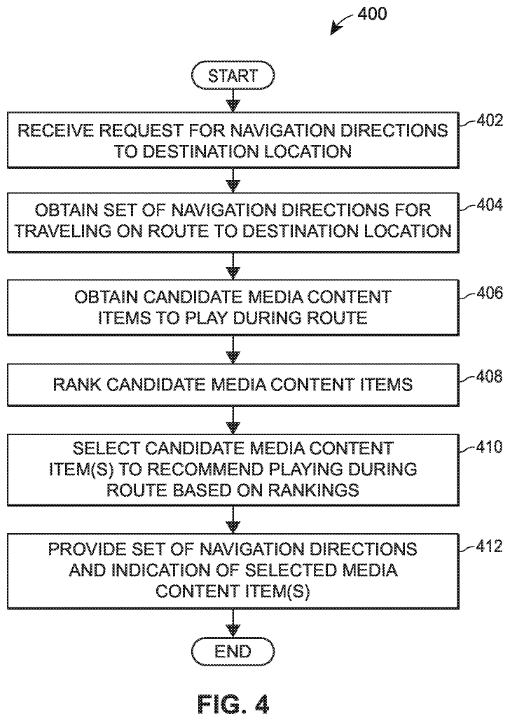

FIG. 4 illustrates a flow diagram of an example method 400 for providing media content tailored to a user's route. The method 400 can be implemented in a set of instructions stored on a computer-readable memory and executable at one or more processors of the server device 60. For example, the method can be implemented by the content curation engine 68. In other implementations, the method 400 can be implemented in a set of instructions stored on a computer-readable memory and executable at one or more processors of the client device 10. For example, the method 400 can be implemented by the content presentation module 134 and/or the mapping application 122. In yet other implementations, the method 400 may be implemented by a combination of the content presentation module 134 and the content curation engine 68.

At block 402, a request is received for navigation directions for traveling to a destination location. For example, a user may provide the request for navigation directions via the client device 10 which may be transmitted to the server device 60.

In response to the request, the server device 60 may obtain a set of navigation directions for traveling along a route to the destination location (block 404). For example, the server device 60 may communicate with the navigation data server 34 to obtain the set of navigation directions. In some implementations, the server device 60 may obtain multiple sets of navigation directions for traveling to the destination location along alternative routes.

Then at block 406, the server device 60 may obtain a set of candidate media content items to play during the route. For example, the client device 10 may invoke an API to retrieve indications of candidate media content items at a third-party content server 72 and may provide the indications of the candidate media content items to the server device 60. In other implementations, the server device 60 may invoke the API to retrieve indications of candidate media content items from the third-party content server 72. The server device 60 may also communicate with a first-party content server 70 to retrieve additional indications of candidate media content items. Additionally, the server device 60 may crawl the Internet for candidate media content items.

At block 408, the content curation engine 68 may rank the candidate media content items. In some implementations, the content curation engine 68 may rank the candidate media content items as described above. For example, the content curation engine 68 may rank the candidate media content items based on a comparison of the characteristics of each candidate media content item to characteristics of the route, the relevance of each candidate media content item to user preferences, the recency of each candidate media content, etc. When the server device 60 obtains multiple alternative routes, the content curation engine 68 may rank the candidate media content items for each alternative route. Then the content curation engine 68 may select candidate media content item(s) to recommend playing, or to automatically play, during each alternative route.

The content curation engine 68 may filter out candidate media content items having durations which are more than a threshold amount longer than the expected duration of the route. The content curation engine 68 may then rank the remaining candidate media content items based on characteristics of each candidate media content item and/or characteristics of the route. For example, the content curation engine 68 may assign scores to several characteristics and combine the scores in any suitable manner to generate an overall score for each candidate media content item. Then the content curation engine 68 may rank the candidate media content items in accordance with their assigned scores.

More specifically, the content curation engine 68 may assign a duration score to each candidate media content item based on the difference between the duration of the candidate media content item and the expected duration of the route.

The content curation engine 68 may also assign a mode of transportation score to each candidate media content item based on the content type and the mode of transportation for the route. When the mode of transportation requires the user to focus on the road, such as driving, walking, or biking, content types which include video may be scored below content types which only include audio. On the other hand, when the mode of transportation does not require the user to focus as closely on the road, such as public transportation, taxi, or ride sharing, content types which include video may be scored above content types which only include audio or both content types may be scored the same.

Furthermore, the content curation engine 68 may optionally assign a relevance score to each candidate media content item based on the user's interests or previous content selections, which may be stored in a user profile at the server device 60. Additionally, in some scenarios, the user may flag certain candidate media content items on a watch list. For example, the user may flag the candidate media content items within the respective applications 132 in which they are provided. Then the content curation engine 68 may increase the relevance score of candidate media content items flagged by the user to watch or listen to.

The content curation engine 68 may also optionally assign a route habit score to each candidate media content item based on an amount in which the candidate media content item aligns with the user's route habits. The content curation engine 68 may compare each candidate media content item to the user's route habits, the starting location of the route, the destination of the route, the time of day of the route, and/or the day of the week of the route to assign the route habit scores.

Still further, the content curation engine 68 may optionally assign a recency score to each candidate media content item based on how recently the candidate media content item was released.

The content curation engine 68 may then combine the scores in any suitable manner to generate an overall score for each candidate media content item. In some implementations, the content curation engine 68 may assign weights to each score and combine the weighted scores to generate the overall score. For example, the content curation engine 68 may assign higher weights to scores related to the route (e.g., the duration score, the route habit score, and the mode of transportation score) than scores which are not related to the route (e.g., the relevance score and the recency score). Then the content curation engine 68 may rank the candidate media content items in accordance with their overall scores.

In some implementations, in addition or as an alternative to assigning a mode of transportation score, the content curation engine 68 may adjust the rankings for certain candidate media content items based on the mode of transportation and/or the content type of the candidate media content items. For example, the content curation engine 68 may boost audio content items for driving, walking, or biking directions. In another example, the content curation engine 68 may boost video content items for public transportation, taxi directions, or ride sharing directions.

In other implementations, the content curation engine 68 may filter out the video component of candidate media content items when the mode of transportation is driving, walking, or biking directions.

Then at block 410, the content curation engine 68 may select candidate media content item(s) to recommend playing, or to automatically play, during the route based on the rankings. For example, the content curation engine 68 may select the highest ranking candidate media content item. In another example, the content curation engine 68 may first select the highest ranking candidate media content item and then continue selecting the next highest ranking candidate media content item until the total duration of the selected media content items is within a threshold time interval of the expected duration of the route. Such selected candidate media content item(s) may be recommended, or alternatively they may be arranged to play automatically during the route.

In other implementations, the content curation engine 68 may provide the filtered candidate media content items in a ranked order or unranked to the client device 10 for display to the user. The user may then select media content item(s) from the filtered candidate media content items to play during the route, for example via user controls.

At block 412, the content curation engine 68 may provide the set(s) of navigation directions and selected media content item(s) for each set of navigation directions to the client device 10 for presentation to the user. The content curation engine 68 may also select and/or adjust a playback rate for each content item based on the duration of the content item and the expected duration of the route. For example, if the duration of the content item is 5% shorter than the expected duration of the route, the content curation engine 68 may select and/or adjust a playback rate that increases the duration of the content item by 5%. If the duration of the content item is 5% longer than the expected duration of the route, content curation engine 68 may select and/or adjust a playback rate that decreases the duration of the content item by 5%. The content curation engine 68 may also provide an indication of the selected/adjusted playback rate to the client device 10. Then the client device 10 may present the media content item(s) in accordance with the selected/adjusted playback rate(s).

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 400 may include one or more function blocks, modules, individual functions or routines in the form of tangible computer-executable instructions that are stored in a non-transitory computer-readable storage medium and executed using a processor of a computing device (e.g., a server device, a personal computer, a smart phone, a tablet computer, a smart watch, a mobile computing device, or other client computing device, as described herein). The method 400 may be included as part of any backend server (e.g., a map data server, a navigation server, or any other type of server computing device, as described herein), client computing device modules of the example environment, for example, or as part of a module that is external to such an environment. Though the figures may be described with reference to the other figures for ease of explanation, the method 400 can be utilized with other objects and user interfaces. Furthermore, although the explanation above describes steps of the method 400 being performed by specific devices (such as a server device 60 or client computing device 10), this is done for illustration purposes only. The blocks of the method 400 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for providing tailored content recommendations through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for providing media content tailored to a user's route, the method comprising:
receiving, at one or more processors, a request for navigation directions to a destination location;
obtaining, by the one or more processors, a set of navigation directions for traveling on a route to the destination location;
obtaining, by the one or more processors, a plurality of candidate media content items to play during the route;
selecting, by the one or more processors, one or more of the plurality of candidate media content items to play during the route based on one or more characteristics of the plurality of candidate media content items and one or more characteristics of the route; and
providing, by the one or more processors, the set of navigation directions and an indication of the selected one or more media content items to a user for presentation during the route,
wherein the selected one or more media content items are automatically presented upon receiving a selection by the user to initiate a navigation session for traveling along the route in accordance with the set of navigation directions.

2. The method of claim 1, further comprising:
identifying, by the one or more processors, at least one segment of the route likely to have poor network connectivity; and
pre-fetching, by the one or more processors, a portion of the selected one or more media content items expected to be playing during the identified segment of the route.

3. The method of claim 1, wherein:
obtaining a set of navigation directions includes obtaining a plurality of alternative sets of navigation directions for traveling along a plurality of alternative routes to the destination location;
selecting one or more of the plurality of candidate media content items to play during the route includes for each of the plurality of alternative routes, selecting a different set of one or more candidate media content items to play during the alternative route based on the one or more characteristics of the plurality of candidate media content items and one or more characteristics of the alternative route; and
providing the set of navigation directions and the selected one or more media content items includes providing each of the plurality of alternative routes and indications of the different sets of one or more candidate media content items corresponding to each alternative route.

4. The method of claim 1, further comprising:
adjusting, by the one or more processors, a playback rate of the selected one or more media content items so that a duration of the selected one or more media content items matches an expected duration of the route.

5. The method of claim 1, wherein selecting one or more of the plurality of candidate media content items to play during the route includes comparing a duration of each candidate media content item to an expected duration of the route to select one of the plurality of candidate media content items having a duration within a threshold time interval of the expected duration of the route.

6. The method of claim 1, wherein selecting one or more of the plurality of candidate media content items to play during the route includes:
ranking, by the one or more processors, each of the plurality of candidate media content items according to:
a comparison of the one or more characteristics of the candidate media content item to the one or more characteristics of the route, and at least one of:
a relevance metric based on user preferences, or a recency metric; and
selecting, by the one or more processors, a subset of the plurality of candidate media content items ranked above a threshold ranking.

7. The method of claim 6, wherein the threshold ranking is selected such that a total duration of the selected subset of candidate media content items is within a threshold time interval of the expected duration of the route.

8. The method of claim 6, further comprising:
adjusting, by the one or more processors, the rankings of the plurality of candidate media content items based on a mode of transport for the route, such that audio content items are boosted for driving, walking, or biking directions, and video content items are boosted for public transportation, taxi directions, or ride sharing directions.

9. A computing device for providing media content tailored to a user's route, the computing device comprising:
one or more processors; and
a non-transitory computer-readable memory coupled to the one or more processors and the speaker and storing instructions thereon that, when executed by the one or more processors, cause the computing device to:
receive a request for navigation directions to a destination location;
obtain a set of navigation directions for traveling on a route to the destination location;
obtain a plurality of candidate media content items to play during the route;
select one or more of the plurality of candidate media content items to play during the route based on one or more characteristics of the plurality of candidate media content items and one or more characteristics of the route; and
provide the set of navigation directions and an indication of the selected one or more media content items to a user for presentation during the route,
wherein the selected one or more media content items are automatically presented upon receiving a selection by the user to initiate a navigation session for traveling along the route in accordance with the set of navigation directions.

10. The computing device of claim 9, wherein the instructions further cause the computing device to:
identify at least one segment of the route likely to have poor network connectivity; and
pre-fetch a portion of the selected one or more media content items expected to be playing during the identified segment of the route.

11. The computing device of claim 9, wherein:
the set of navigation directions include a plurality of alternative sets of navigation directions for traveling along a plurality of alternative routes to the destination location;
to select one or more of the plurality of candidate media content items to play during the route, the instructions cause the computing device to for each of the plurality of alternative routes, select a different set of one or more candidate media content items to play during the alternative route based on the one or more characteristics of the plurality of candidate media content items and one or more characteristics of the alternative route; and
to provide the set of navigation directions and the selected one or more media content items, the instructions cause the computing device to provide each of the plurality of alternative routes and indications of the different sets of one or more candidate media content items corresponding to each alternative route.

12. The computing device of claim 9, wherein the instructions further cause the computing device to
adjust a playback rate of the selected one or more media content items so that a duration of the selected one or more media content items matches an expected duration of the route.

13. The computing device of claim 9, wherein to select one or more of the plurality of candidate media content items to play during the route, the instructions cause the computing device to compare a duration of each candidate media content item to an expected duration of the route to select one the plurality of candidate media content items having a duration within a threshold time interval of the expected duration of the route.

14. The computing device of claim 9, wherein to select one or more of the plurality of candidate media content items to play during the route, the instructions cause the computing device to:
rank each of the plurality of candidate media content items according to:
a comparison of the one or more characteristics of the candidate media content item to the one or more characteristics of the route, and at least one of:
a relevance metric based on user preferences, or a recency metric; and
select a subset of the plurality of candidate media content items ranked above a threshold ranking.

15. The computing device of claim 14, wherein the threshold ranking is selected such that a total duration of the selected subset of candidate media content items is within a threshold time interval of the expected duration of the route.

16. The computing device of claim 14, wherein the instructions further cause the computing device to
adjust the rankings of the plurality of candidate media content items based on a mode of transport for the route, such that audio content items are boosted for driving, walking, or biking directions, and video content items are boosted for public transportation, taxi directions, or ride sharing directions.

17. A method for providing media content tailored to a user's route, the method comprising:
receiving, at one or more processors, a request for navigation directions to a destination location;
obtaining, by the one or more processors, a set of navigation directions for traveling on a route to the destination location;
obtaining, by the one or more processors, a plurality of candidate media content items to play during the route;
receiving, at the one or more processors, a selection of one or more of the plurality of candidate media content items to play during the route; and
providing, by the one or more processors, the set of navigation directions and an indication of the selected one or more media content items to a user for presentation during the route,
wherein the selected one or more media content items are automatically presented upon receiving a selection by the user to initiate a navigation session for traveling along the route in accordance with the set of navigation directions.

18. The method of claim 17, wherein receiving a selection of one or more of the plurality of candidate media content items includes:
providing, by the one or more processors, the plurality of candidate media content items for display to the user; and
receiving, via a user control, a selection by the user of one or more of the plurality of candidate media content items to play during the route.

19. The method of claim 18, wherein providing the plurality of candidate media content items for display to the user includes:
ranking, by the one or more processors, each of the plurality of candidate media content items based on one or more characteristics of the candidate media content item and one or more characteristics of the route; and
providing, by the one or more processors, the plurality of candidate media content items for display to the user in a ranked order.

20. The method of claim 17, further comprising:
adjusting, by the one or more processors, a playback rate of the selected one or more media content items so that a duration of the selected one or more media content items matches an expected duration of the route.
